(19) United States
(12) Patent Application Publication
(10) Pub. No.: US 2006/0021130 A1
(43) Pub. Date: Feb. 2, 2006

(54) Multiple nozzle moving jet structure for spa

(76) Inventor: Christopher Larsen, Vista, CA (US)

Correspondence Address: SNELL & WILMER L.L.P., Suite 1200, 1920 Main Street, Irvine, CA, 92614-7230, US

(21) Appl. No.: 10/899,547

(22) Filed: Jul. 27, 2004

(51) Int. Cl. A61H 33/04

(52) U.S. Cl. 4/541.6

(57) ABSTRACT

A multiple nozzle moving jet structure for a spa, attached to flexible tubes encased in an articulated sleeve exhausts pressurized water into the spa in a vertical whipping motion, in reaction to the water exhaust. The multiple nozzle structure utilizes one air supply tube to aerate water streams of the multiple nozzle structure. The combination of the multiple nozzle structure with the articulated sleeves on the flexible tubes, confines movement of the nozzle structure in one plane, eliminating the requirement for a guide body to confine direction of nozzle movement.

### BACKGROUND OF THE INVENTION

1. Field of the Invention

The present invention relates generally to improvements in spas or hot tubs, and more particularly, pertains to new and improved nozzles for ejecting water into spas wherein, the nozzles physically moved.

2. Description of Related Art

In the field of providing moving water stream ejection into spa containers, it has been the practice to employ water tubes pivoting in a vertical plane to exhaust a massaging water stream on the back of the user sitting in the spa. One of the problems confronting such devices has been the problem of keeping the water tubes confined to movement in the vertical plane. Prior art devices such as, described in U.S. Pat. No. 4,523,340 granted Jun. 18, 1985 for a Means Providing Moving Water Stream Ejecting Into Spa Tank, U.S. Pat. No. 4,716,604 granted Jan. 5, 1988 for a Spa With Moving Jets, and U.S. Pat. No. 4,920,588 granted May 1, 1990 for a Means Providing Moving Water Stream Ejecting Into Spa Tank, utilized as specially designed guide body to guide the moving nozzles to move only in the vertical plane.

FIG. 1 is an illustration of a prior art, single nozzle moving jet structure. This type of structure is described in detail in U.S. Pat. Nos. 4,523,340, 4,716,604, and 4,920,588. These structures all have a single nozzle 21, connected to a source of air supply by tubing 25, and a source of pressurized water by tubing 23. The pressurized water is supplied to the nozzle 21 in a flexible tube encased in an articulated plastic sleeve structure. This articulated sleeve structure is more specifically described in U.S. Pat. No. 4,716,604, which is assigned to the assignee of the present invention. The nozzle 21 moves up and down vertically, as the result of a whipping reaction to the exhaust water from the nozzle. The nozzle 21 is confined to the vertical path of travel by the combination of the articulated plastic sleeve over tubing 23, and the guide body 17, which is a series of fins or ribs, as described in detail in U.S. Pat. No. 4,716,604. The water from the nozzle 21 is ejected through an opening or series of ports 19 on a face plate 13. Face plate 13 mounts to a flange 15 which is attached to the tank wall of the spa, in a manner described in detail in U.S. Pat. Nos. 4,523,340, 4,716,604 and 4,920,588.

In contrast, the present invention increases the amount of massaging water streams on the back of a user, while at the same time eliminating the requirement for using guide bodies and reducing the amount of air supply tubing line required.

### SUMMARY OF THE INVENTION

A multiple nozzle structure mounted to respective pressurized water tubes which are individually encased in articulated sleeves with one air supply tube supplying air to all the nozzles, confines the nozzle structure movement resulting from the water exhaust, to one plane. No guide body is required to confine the direction of movement of the nozzle structure. Movement of the nozzle structure is preferred in the vertical plane to obtain movement up and down the back of a person in the spa.

### BRIEF DESCRIPTION OF THE DRAWINGS

The exact nature of this invention, as well as its objects and many of the attended advantages, will become readily apparent upon reference to the following detailed description considered in conjunction with the accompanying drawings in which like reference numerals designate like parts throughout the figures thereof and wherein:

FIG. 1 is a back perspective of a prior art, single nozzle moving jet structure.

FIG. 2 is a top perspective of a multiple nozzle moving jet structure, according to the present invention.

FIG. 3 is a side perspective of the multiple nozzle moving jet structure of FIG. 2.

FIG. 4 is back perspective of the multiple nozzle moving jet structure of FIG. 2.

FIG. 5 is a cross section of a preferred embodiment of the multiple nozzle used in the multiple nozzle moving jet structure of the present invention.

### DETAILED DESCRIPTION OF THE PREFERRED EMBODIMENTS OF THE INVENTION

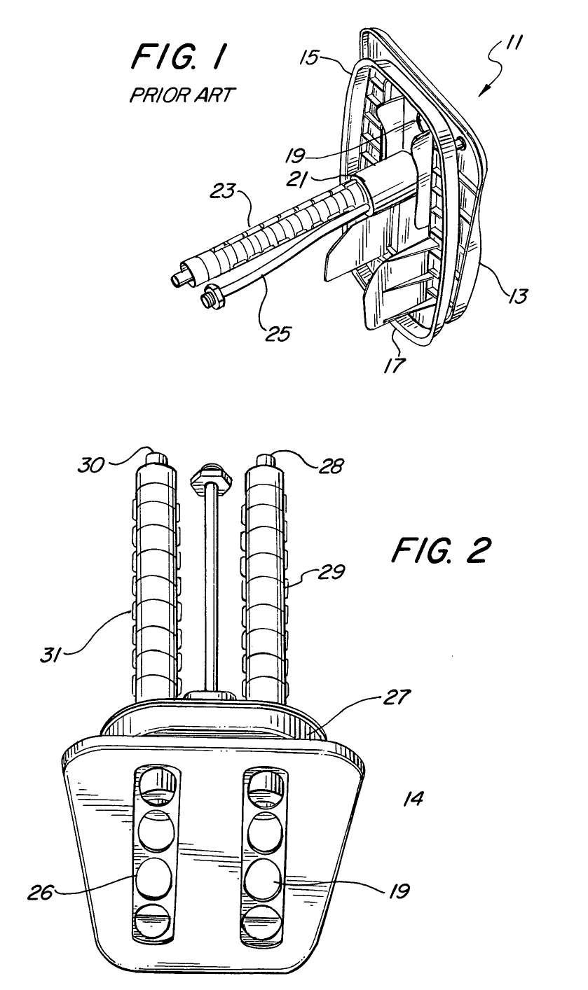

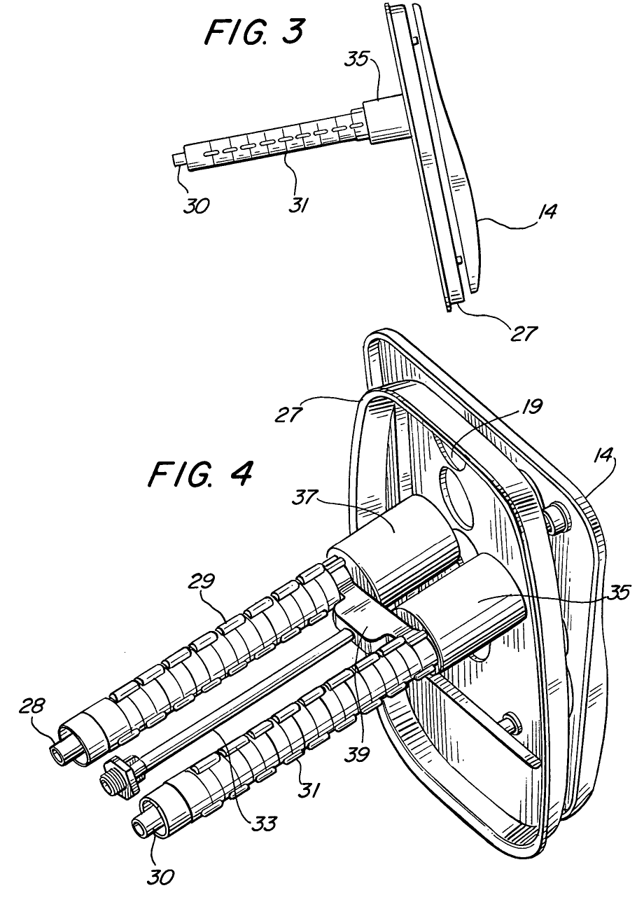

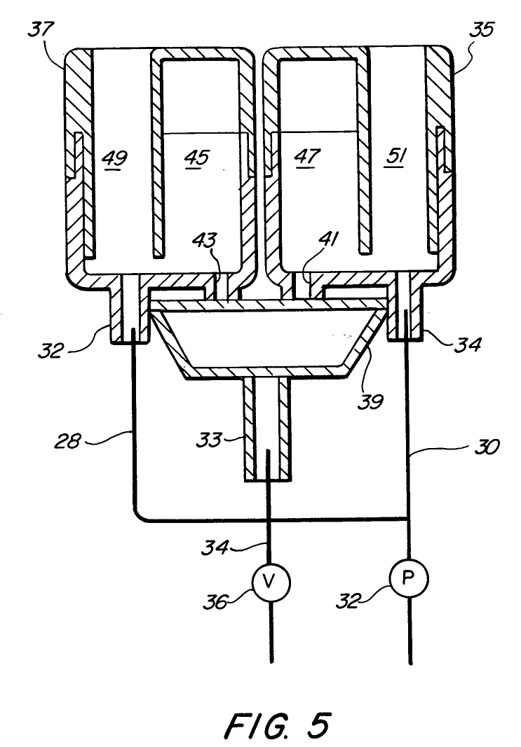

FIGS. 2, 3 and 4 illustrate a preferred embodiment of the present invention as having a two nozzle moving jet structure. Each nozzle 35, 37 is supplied with pressurized water over respective flexible tubing 30 and 28. A single air line 33 supplies air to an air manifold 39, which physically attaches to both nozzles 35 and 37 in a manner that makes the two nozzle 35 and 37 a single unit.

Each of the flexible water supply tubes 30 and 28 are encased in respective articulated plastic sleeves 31 and 29, of the type described in U.S. Pat. No. 4,716,604 granted Jun. 5, 1988 for a Spa With Moving Jets. The entire disclosure of U.S. Pat. No. 4,716,604 is incorporated herein by reference, as if fully set forth here.

The multiple articulated sleeves 29 and 31 in conjunction with the multiple jet 37, 35 moving structure, constrains movement of the multiple jet head 35, 37 to a single chosen plane, which in the figures, is illustrated to be a vertical plane. It should be kept in mind, however, that the chosen plane could be other than vertical. The chosen plane could be horizontal, for example, or a plane at an angle to the horizontal, as desired.

At mounting flange 27, which is attached to the tank wall of the spa, acts as a support for the face plate 14, which has a first plurality of apertures 19 and a parallel second plurality of apertures 26 aligned vertically, to allow water being ejected from the nozzles 35 and 37 to be injected into the body water in the spa (not shown).

The multiple nozzle moving jet structure of the present invention does not only eliminates the need for a guide body structure, for guiding nozzle movement, but it also provides a more significant quantity of massaging jets which is a quantum improvement to the experience of the occupant in the spa tank.

An air manifold 39, which receives air from a flexible air supply tube 33, physically connects the jets 35 and 37 together, as well as supplying air to each of the jets, in a manner more clearly illustrated in FIG. 5.

FIG. 5, which is a cross section of a two nozzle moving jet structure shows the air manifold 39 receiving air by way of a flexible air supply line 33, from an air line 34 that is connected to a valve 36, which opens to the atmosphere. Air manifold 39 is connected to nozzle 35 by passage 41, and is connected to nozzle 37 by passage 43. Pressurized water is supplied to nozzle 35 by flexible tubing 30 that attaches to an input nipple 34. Flexible tubing 30 is connected to a pump 32, that pumps water from the spa tank. Nozzle 37 receives pressurized water over flexible tubing 28 from the pump 32. Tubing 28 attaches to the input nipple 32 of nozzle 37.

The structure of nozzles 35 and 37 are identical in that, each has an exhaust tube 51 and 49 with a space at the bottom for drawing air, in a venture or vacuum manner, through the gap from respective air chambers 47 and 45. The specific operation of nozzles such as nozzles 35 and 37 is explained in detail in U.S. Pat. No. 4,920,588, the disclosure thereof being incorporated herein by reference, as if fully set forth here.

It should be remembered that more than two nozzles could be utilized in a multiple nozzle moving jet structure, according to the present invention, and using more than two nozzles is contemplated within the present invention. The arrangement of three or more nozzles in combination with the air manifold, using the nozzle structure illustrated, or an alternate nozzle structure, is considered part of the present invention.

What is claimed is:

1. A moving jets structure for a spa having a tank containing water for body immersion and a source of pressurized water, the improvement comprising:
a nozzle structure having multiple nozzles; and
flexible tubes, one for each nozzle, connected to the source of pressurized water and to a respective nozzle in the nozzle structure.

2. The moving jets structure of claim 1 further comprising:
articulated sleeves one for each flexible tube for encircling each of the flexible tubes and limiting the flexing of each tube.

3. The moving jets structure of claim 1 further comprising:
an air supply for supplying air to the multiple nozzles in the nozzle structure.

4. The moving jets structure of claim 1 further comprising:
an air manifold connected to supply air to each of the nozzles in the nozzle structure.

5. The moving jets structure of claim 4 further comprising an air supply tube connected to the air manifold and atmospheric air.

6. The moving jets structure of claim 1 wherein the nozzle structure includes an air manifold for supplying air to each of the nozzles in the nozzle structure.

7. The moving jets structure of claim 6 further comprising an air supply tube connected to the air manifold and atmospheric air.

8. The moving jets structure of claim 7 further comprising articulated sleeves encircling each of the flexible tubes for limiting the flexing of each tube to the same plane.

9. A moving jets structure for a spa having a tank containing water for body immersion and a source of pressurized water, the improvement comprising:
a two nozzle structure having two separate nozzles aligned side by side; and
two flexible tubes connected to the source of pressurized water and to a respective nozzle in the two nozzle structure.

10. The moving jets structure of claim 9 further comprising:
an articulated sleeve encircling each of the two flexible tubes for limiting the flexing of each tube.

11. The moving jets structure of claim 9 further comprising an air supply for supplying air to the two nozzle structure.

12. The moving jets structure of claim 9 further comprising an air manifold connected to supply air to each of the two nozzles in the nozzle structure.

13. The moving jets structure of claim 12 further comprising an air supply tube connected to the air manifold and atmospheric air.

14. The moving jets structure of claim 9, wherein the two nozzle structure includes an air manifold for supplying air to each of the two nozzles in the nozzle structure.

15. The moving jets structure of claim 14 further comprising an air supply tube connected to the air manifold and atmospheric air.

16. The moving jets structure of claim 15 further comprising an articulated sleeve encircling each of the two flexible tubes for limiting the flexing of each tube.

17. The moving jets structure of claim 16, wherein the flexing of each tube is limited to a vertical plane.
